(19) United States
(12) Patent Application Publication
(10) Pub. No.: US 2026/0318505 A1
(43) Pub. Date: Oct. 15, 2026

(54) DISPLAY DEVICE

(71) Applicants: Panasonic Automotive Systems Co., Ltd., Yokohama-shi (JP); Panasonic Holdings Corporation, Osaka (JP)

(72) Inventors: Yuma SASAGAWA, Osaka (JP); Hideaki ETO, Osaka (JP); Yasuhisa KUWAMURO, Osaka (JP); Kazuhiko KANEUCHI, Osaka (JP)

(21) Appl. No.: 19/638,625

(22) Filed: Apr. 3, 2026

(30) Foreign Application Priority Data
Apr. 11, 2025 (JP) 2025-065674

(51) Int. Cl. F21V 11/00

(52) U.S. Cl. CPC F21V 11/00

(57) ABSTRACT

A display device includes: a display sheet having a front surface and a back surface, wherein the display sheet has a cushioning property and displays a design including a character/symbol on the front surface when light is emitted from the back surface; and, a light source that emits light from the back surface of the display sheet, wherein the display sheet includes: a skin member; a light shielding/smoke layer disposed on the front side of the skin member or the back side of the skin member, and the light shielding/smoke layer constituting the design including the character/symbol; a cushioning member disposed on the back side of the skin member, the cushioning member being formed with a foam material, and having a plurality of air bubbles, and having optical transparency for diffusing and transmitting irradiated light; and a transparent member disposed on the back side of the cushioning member, and the transparent member being able to transmit irradiated light; and wherein the cushioning member has an average diameter of the air bubbles in the foam material of 0.7 mm or less.

### CROSS REFERENCE TO RELATED APPLICATION

This application claims a priority of Japanese Patent Application No. 2025-65674 filed on Apr. 11, 2025, the content of which is incorporated herein by reference.

### BACKGROUND OF THE INVENTION

### 1. Field of the Invention

The present disclosure relates to a display device having a cushioning property and capable of displaying a design by light.

### 2. Description of the Related Art

In recent years, a light emission display device and an input device are disposed in a vehicle interior of an automobile in a wide variety of places. For example, a light emission display device or an input device is increasingly disposed in a place having a cushioning property such as an instrument panel or a door trim, and there are also increasing needs to dispose the light emission display device or the input device in a place having a higher cushioning property, for example, an armrest.

In response to these needs, for example, JP 2025-29931 A (Patent Document 1) discloses a light emission display device that can have a cushioning property by providing a cushion layer such as a foam under a skin material and providing another translucent cushion material in a translucent display unit.

From the viewpoint of comfort and luxuriousness in a vehicle interior of an automobile, or the like, interior parts that require to perform display and provide tactile sensation are requested to have more seamless design and operability.

JP 2023-86524 A (Patent Document 2) discloses a light emission display device using a foam having a HAZE value of 95% or more for a cushion layer provided under a skin material. This display device is configured to achieve seamless operability while suppressing lighting unevenness due to air bubbles in the foam by defining the HAZE value of the foam. Note that the HAZE value is a diffusivity with respect to transmitted light.

### SUMMARY

In the related art, a cushion layer formed with a foam material is used for a portion requiring a cushioning property. However, in a case where a cushioning property is imparted to a display device that displays a design by transmitting light generated from a light source through a skin material, if a foam is used for the cushion layer, there is a problem that shadow of air bubbles in a foam material constituting the cushion layer is displayed as lighting unevenness on a design portion, or light passing through the air bubbles can be visually recognized as point light.

In the display device of Patent Document 1 described above, lighting unevenness due to air bubbles can be prevented by using a cushion material different from the foam only for the translucent display unit, but it is insufficient in terms of seamless tactile sensation. In addition, in the display device described in Patent Document 2, while preventing lighting unevenness due to air bubbles by diffusing light using a foam having a high HAZE value and enabling seamless tactile sensation, it is difficult to increase a total light transmittance and an expansion ratio of the foam having a high HAZE value, and it is insufficient to achieve a high cushioning property and luminous intensity.

The present disclosure is intended to solve the above-mentioned problems, and one non-limiting and exemplary embodiments provides a display device having a high cushioning property by a foam material and good design visibility by light transmission.

In one general aspect, the techniques disclosed here feature: a display device includes:
a display sheet having a front surface and a back surface, wherein the display sheet has a cushioning property and displays a design including a character/symbol on the front surface when light is emitted from the back surface; and
a light source that emits light from the back surface of the display sheet,
wherein the display sheet includes:
   a skin member;
   a light shielding/smoke layer disposed on the front side of the skin member or the back side of the skin member, and the light shielding/smoke layer constituting the design including the character/symbol;
   a cushioning member disposed on the back side of the skin member, the cushioning member being formed with a foam material, and having a plurality of air bubbles, and having optical transparency for diffusing and transmitting irradiated light; and
   a transparent member disposed on the back side of the cushioning member, and the transparent member being able to transmit irradiated light; and
wherein the cushioning member has an average diameter of the air bubbles in the foam material of 0.7 mm or less.

According to the display device of the present disclosure, even in a case where a design portion is displayed with high luminance while having a high cushioning property, it is possible to suppress lighting unevenness of the design portion caused by air bubbles in a foam material constituting a cushioning member.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is a schematic cross-sectional view illustrating a cross-sectional configuration of a display device according to a first embodiment;

FIG. 2 is a schematic cross-sectional view illustrating a cross-sectional configuration of a display device according to a first experimental example;

FIG. 3 is Table 1 illustrating illuminated photographs of a front surface side irradiated with light from a back surface of a display sheet, partially enlarged views thereof, and evaluation values in display devices according to first to fourth experimental examples and a first comparative example;

FIG. 4 is a schematic cross-sectional view illustrating a cross-sectional configuration of a display device according to a fifth experimental example; and

FIG. 5 is Table 2 summarizing an illuminated photograph in a case where a light source is arranged immediately below a transmission portion in a case where the transmission portion is a figure indicating a switch, an illuminated photograph in a case where the light source is arranged at an upper left end of the transmission portion in a case where the transmission portion is a horizontal line, an illuminated photograph in a case where the light source is arranged immediately below the transmission portion, and partially enlarged views thereof illustrating states of air bubbles in display device according to fifth to eighth experimental examples and a second comparative example.

### DETAILED DESCRIPTION

A display device according to a first aspect, includes:
a display sheet having a front surface and a back surface, wherein the display sheet has a cushioning property and displays a design including a character/symbol on the front surface when light is emitted from the back surface; and
a light source that emits light from the back surface of the display sheet,
wherein the display sheet includes:
   a skin member;
   a light shielding/smoke layer disposed on the front side of the skin member or the back side of the skin member, and the light shielding/smoke layer constituting the design including the character/symbol;
   a cushioning member disposed on the back side of the skin member, the cushioning member being formed with a foam material, and having a plurality of air bubbles, and having optical transparency for diffusing and transmitting irradiated light; and
   a transparent member disposed on the back side of the cushioning member, and the transparent member being able to transmit irradiated light; and
wherein the cushioning member has an average diameter of the air bubbles in the foam material of 0.7 mm or less.

In the display device according to a second aspect in addition to the first aspect, the cushioning member may have a foaming ratio of the foam material of 50 times or more and 100 times or less.

In the display device according to a third aspect in addition to the first or second aspect, the cushioning member may have a total light transmittance of 40% or more.

In the display device according to a fourth aspect in addition to any one of the first to third aspects, the skin member may have a total light transmittance of 5% or more and 25% or less.

Hereinafter, a display device according to an embodiment of the present disclosure will be described with reference to the accompanying drawings.

### First Embodiment

### <Display Device>

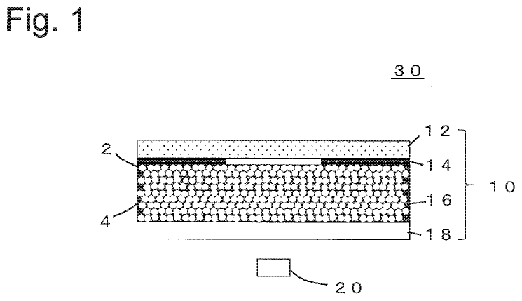

FIG. 1 is a schematic cross-sectional view of a display device 30 according to a first embodiment.

The display device 30 according to the first embodiment includes a display sheet 10 that displays a design including a character/symbol on a front surface when light is emitted from a back surface, and a light source 20 that emits light from the back surface of the display sheet. The display sheet 10 includes a skin member 12, a light shielding/smoke layer 14 constituting a design including a character/symbol, a cushioning member 16 having flexibility, and a transparent member 18 that is disposed on a back side of the cushioning member 16 and transmits irradiated light. The light shielding/smoke layer 14 is disposed on the front side of the skin member 12 or the back side of the skin member 12. The cushioning member 16 is disposed on the back side of the skin member 12, the cushioning member 16 has optical transparency for diffusing and transmitting light irradiated from the back surface. The cushioning member 16 is formed with a foam material 4, has a plurality of air bubbles 2. The air bubbles 2 in the foam material 4 have an average diameter of 0.7 mm or less.

As a result, even in a case where a design portion is displayed with high luminance, it is possible to suppress shadow of the air bubbles 2 in the foam material 4 constituting the cushioning member from being displayed as lighting unevenness on the design portion.

Hereinafter, components constituting the display device 30 will be described.

### <Skin Member>

The skin member has optical transparency. A material of the skin member is not particularly limited, but may be, for example, a synthetic leather using a flexible resin such as a polyurethane resin, a thermoplastic elastomer, and a vinyl chloride resin which can be produced at lower cost than a natural leather. A thickness of the skin member is not particularly limited as long as target tactile sensation can be obtained, but if the thickness is too thick, operability (flexible tactile sensation) may be deteriorated, and if the thickness is too thin, durability performance such as breakage may be impaired. Thus, the thickness of the skin member is, for example, from 0.2 to 2.0 mm, and may be from 0.3 to 1.0 mm.

### <Light Shielding/Smoke Layer>

As illustrated in FIG. 1, a light shielding/smoke layer 14 may be provided on a surface (back surface side) of the skin member on the light source side. In addition, the light shielding/smoke layer 14 may be provided on a surface (front surface side) of the skin member 12 on the side opposite to the light source. The light shielding/smoke layer 14 is formed by, for example, printing or painting, and has a light transmission region that transmits light from the light source in the light shielding/smoke layer, and a shape of the light transmission region may be a symbol design including a character/symbol.

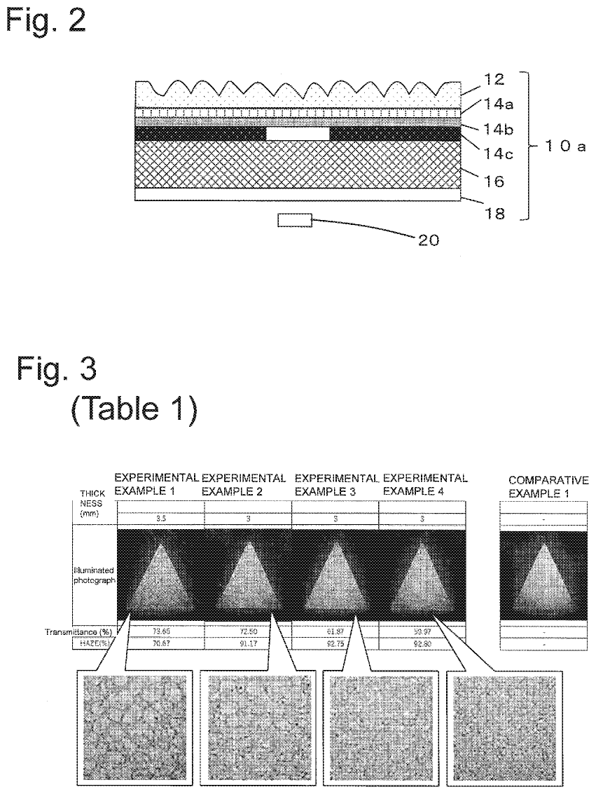

As illustrated in FIG. 2, instead of one layer, a smoke layer 14a, a first light shielding layer 14b, and a second light shielding layer 14c may be laminated as different layers.

The smoke layer 14a may be formed by, for example, injection molding using a colored resin instead of printing or painting.

A total light transmittance through the skin member and the light transmission region of the light shielding/smoke layer is not particularly limited as long as target illumination luminance can be obtained. However, if the total light transmittance is too low, design characteristics at the time of light emission display may be impaired. Thus, for example, the total light transmittance may be 5% or more, and further 10% or more. On the other hand, if the total light transmittance is too high, the symbol design may be always visible and the designability may be impaired, and thus, the total light transmittance may be, for example, 25% or less, and further 20% or less.

### <Cushioning Member>

The cushioning member is formed with a translucent foam material (foam) having a plurality of air bubbles. The air bubbles in the foam material have an average diameter of 0.7 mm or less. In a case where the average diameter of the air bubbles is larger than 0.7 mm, shadow of the air bubbles is likely to appear in the light from the light source, and the design is likely to be impaired. In addition, in a case where a highly foamed member having a high cushioning property is used, by setting the average air bubble diameter to 0.7 mm or less, light from the light source is easily diffused, and it is possible to suppress an event in which shadow of the air bubbles is visually recognized due to light entering the design from multiple directions. Furthermore, in addition to the above, it is possible to suppress an event in which shadow due to embossment on the surface of the skin member is visually recognized, and it is possible to further improve quality of designability. The air bubble diameter can be measured using an optical microscope, or the like. In addition, by reducing the average air bubble diameter to 0.7 mm or less, a portion of the foamed resin is likely to overlap with an optical path from the light source, and the HAZE value is increased, so that the occurrence of point light can also be effectively suppressed as expected.

An expansion ratio of the cushioning member is not particularly limited, but may be, for example, 100 times or less, and further 70 times or less because if the expansion ratio is too high, a ratio of air increases, the strength decreases, or light from the light source passes through the cushioning member, so that the operability and design property may be impaired. In addition, if the expansion ratio is too low, a ratio of the foam material increases, and the operability may be impaired due to decrease in cushioning property. Thus, the expansion ratio may be, for example, 50 times or more.

The expansion ratio of the foam can be determined by (a volume of the entire foam)/(a volume of the resin material used for the foam).

By limiting the expansion ratio to 100 times or less, the light is easily diffused by fibers of the urethane foam, and the shadow can be made pale by the embossment on an appearance surface being irradiated with light from multiple directions, and the shadow due to the embossment on the appearance surface can be made difficult to be visually recognized.

A thickness of the cushioning member is not particularly limited as long as target tactile sensation can be obtained, but if the thickness is too thick, the optical transparency may be impaired, and if the thickness is too thin, the tactile sensation may be impaired. Thus, the thickness of the cushioning member may be, for example, from 1.0 to 3.0 mm, further from 1.5 mm to 2.5 mm.

A total light transmittance of the cushioning member is not particularly limited as long as the target illumination luminance can be obtained, but if the total light transmittance is too low, the shadow of the air bubbles is easily visually recognized, and the design property at the time of light emission display may be impaired. Thus, the total light transmittance of the cushioning member is, for example, 40% or more, and may be 70% or more.

A material of the cushioning member is not particularly limited, but may be, for example, a urethane-based foam, more preferably a polyolefin-based foam, because the cushioning member is less expensive and easier to process than natural leather.

The color of the cushioning member is not particularly limited as long as target appearance quality can be obtained, but may be, for example, white and may be transparent color in order to suppress a loss of light amount due to absorption of light rays generated from the light source or to suppress discoloration.

### <Transparent Member>

A material of the transparent member is not particularly limited, but for example, a resin material such as polypropylene (PP) or polycarbonate (PC) that easily obtains characteristics of optical transparency may be used. In the transparent member, a light emission display region of the design imprinted on the skin member by two-color molding may be formed with a material having optical transparency, and the other region may be formed with a material having light-shielding property. In a case where a plurality of designs having a light emission display function are imprinted on the skin member, the transparent member may have a light shielding wall having a light shielding property so as to partition each design of the skin member by two-color molding.

### <Light Source>

The same number or a plurality of light sources may be arranged for the design of the skin member. One or a plurality of light sources may be disposed in a region of each light shielding wall of the transparent member. The light source may be, for example, an LED, a light bulb, or the like. Alternatively, a combination of the light source placed at a distant place, and a light guide, a reflector, an optical fiber, or the like, that guides light from the light source may be used.

### <Method of Manufacturing Display Device>

The display device according to the first embodiment may be configured by combining a display sheet in which the skin member, the cushioning member, and the transparent member are laminated, and the light source, for example. In this case, the display sheet may be formed by sequentially laminating the skin member, the cushioning member, and the transparent member. Alternatively, the skin member and the transparent member may be respectively disposed in a core mold and a cavity mold, a foam material may be injection-molded in a cavity between the skin member and the transparent member to form the cushioning member, and the display sheet in which the skin member, the cushioning member, and the transparent member are integrated may be manufactured. Alternatively, only one of the skin member and the transparent member may be disposed in a mold, integrated with the cushioning member, and laminated with the remaining members to form the display sheet.

### <Method of Measuring Air Bubble Diameter>

The air bubble diameter can be measured using a measuring instrument that allows observation at a high magnification such as an optical microscope. For example, for one cross section, a diameter calculated by plotting three points on a circumference for each air bubble and estimating an air bubble shape as a circle may be taken as the air bubble diameter, and the average air bubble diameter may be obtained as an average of ten air bubbles included in one cross section. Note that in a case where there is a significant variation, measurement may be performed at a plurality of places, for example, ten cross sections, and an average thereof may be taken.

### <Number of Air Bubbles (Air Bubble Density)>

The number of air bubbles was observed as the number of air bubbles (/25 mm) included in a length of 25 mm along one direction of a visual field of the optical microscope.

<method of Measuring Expansion Ratio>

In a case where the expansion ratio of a molded foam is unknown after molding, the expansion ratio is calculated from a volume of water increased when the molded foam is immersed in water (apparent volume containing air bubbles in the molded foam) and a volume of the molded foam not containing air bubbles (volume not containing air bubbles in the molded foam, converted from density of a portion of foamable resin structure not containing air bubbles in the molded foam).

### FIRST TO FOURTH EXPERIMENTAL EXAMPLES, FIRST COMPARATIVE EXAMPLE

FIG. 2 is a schematic cross-sectional view illustrating a configuration of a display device according to a first experimental example. FIG. 3 is Table 1 illustrating illuminated photographs of a front surface side irradiated with light from a back surface of the display sheet, partially enlarged views thereof, and evaluation values in display devices according to the first to fourth experimental examples and the first comparative example.

Hereinafter, display devices according to the first to fourth experimental examples and the comparative example will be described.

### First Experimental Example

As illustrated in FIG. 2, a display device 30a according to the first experimental example includes a display sheet including a transparent skin sheet (skin member) 12, a smoke printing 14a, a white printing (peeling) 14b, a black printing 14c, a urethane foam (cushioning member) 16, and a transparent PC sheet (transparent member) 18, and a light source 20 including a LED lighting. The skin sheet had transparent material color and no processing of leather embossment, and for printing, smoke was applied to the entire skin sheet, and then the transmission region was made white and the light shielding region was made black. Further, the skin sheet has a thickness of 1.2 mm.

The urethane foam (cushioning member) had a foaming ratio of 65, the number of air bubbles of 18 (/25 mm), an average air bubble diameter of 1.4 mm, and resin color of white. A thickness of the urethane foam was 3.5 mm. The transparent PC sheet (transparent member) had transparent resin color and a thickness of 0.25 mm.

The skin sheet, urethane foam, and transparent PC sheet were laminated to form a display sheet, and the side of the transparent PC sheet was irradiated with light from the light source to evaluate the light transmittance and the HAZE value.

The light transmittance of the urethane foam was 73.65%, and the HAZE value was 70.67%.

The light transmittance of the laminate was 9.22%, and the HAZE value was 85.14%.

### Second Experimental Example

The display sheet was formed in a similar manner to the first experimental example except that the urethane foam (cushioning member) had an expansion ratio of 64 times, the number of air bubbles of 20 (/25 mm), an average air bubble diameter of 1.2 mm, and a thickness of 3 mm, and the light transmittance and the HAZE value were evaluated by irradiating the transparent PC sheet side with light from the light source.

The light transmittance of the urethane foam was 72.60%, and the HAZE value was 91.17%.

The light transmittance of the laminate was 9.08%, and the HAZE value was 95.53%.

### Third Experimental Example

The display sheet was formed in a similar manner to the first experimental example except that the urethane foam (cushioning member) had an expansion ratio of 57 times, the number of air bubbles of 30 (/25 mm), an average air bubble diameter of 0.8 mm, and a thickness of 3 mm, and the light transmittance and the HAZE value were evaluated by irradiating the transparent PC sheet side with light from the light source.

The light transmittance of the urethane foam was 61.87%, and the HAZE value was 92.75%.

The light transmittance of the laminate was 7.75%, and the HAZE value was 96.33%.

### Fourth Experimental Example

The display sheet was formed in a similar manner to the first experimental example except that the urethane foam (cushioning member) had an expansion ratio of 50 times, the number of air bubbles of 40 (/25 mm), an average air bubble diameter of 0.6 mm, and a thickness of 3 mm, and the light transmittance and the HAZE value were evaluated by irradiating the transparent PC sheet side with light from the light source.

The light transmittance of the urethane foam was 59.97%, and the HAZE value was 92.80%.

The light transmittance of the laminate was 7.51%, and the HAZE value was 96.35%.

### First Comparative Example

The display sheet was formed in a similar manner to the first experimental example except that urethane foam was not used, and the light transmittance and the HAZE value were evaluated by irradiating the transparent PC sheet side with light from the light source.

The light transmittance of the laminate was 12.52%, and the HAZE value was 49.35%.

### <Evaluation>

As illustrated in FIG. 3, it can be seen that if there is no urethane foam (first comparative example: no diffusion), lighting unevenness is conspicuous at the time of light emission display. In a case where the diameter of the air bubble in the urethane foam is large (for example, the first experimental example), it can be seen that the shadow of the air bubbles is visually recognized at the time of light emission display. On the other hand, in a case where the diameter of the air bubble in the urethane foam is small (third and fourth experimental examples), it can be seen that it is difficult to visually recognize the shadow of the air bubbles at the time of light emission display. In particular, in the fourth experimental example (average air bubble diameter: 0.6 mm), the influence of the shadow of the air bubbles is smaller than that in the third experimental example (average air bubble diameter: 0.8 mm). Thus, in consideration of errors and variations, the average air bubble diameter is desirably 0.7 mm or less as described above.

Note that if the air bubble density (the number of air bubbles) increases from 18 air bubbles/25 mm (the first experimental example) to 40 air bubbles/25 mm (the fourth experimental example), the illumination intensity decreases by about 20%. In any case, the haze (HAZE) values of the urethane foam were all 95% or less.

### Fifth to Eighth Experimental Examples, Second Comparative Example

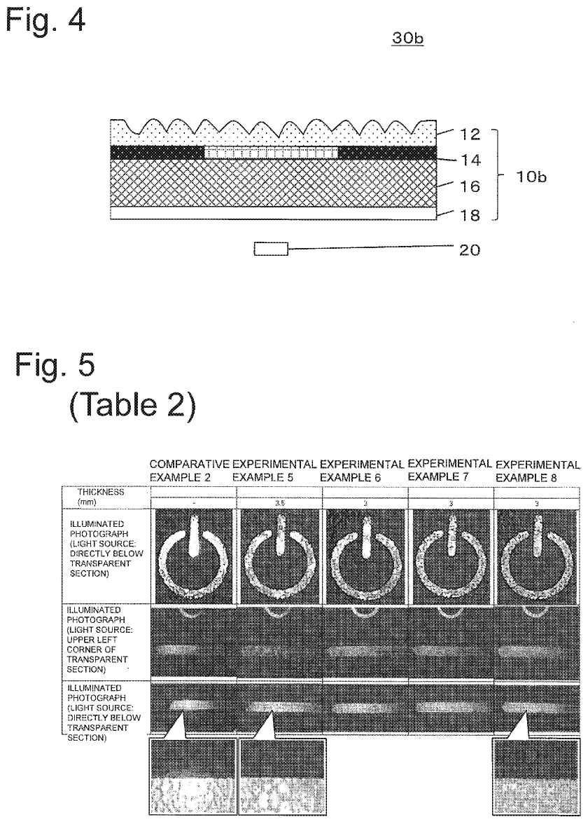

FIG. 4 is a schematic cross-sectional view illustrating a configuration of a display device according to a fifth experimental example. FIG. 5 is an illuminated photograph in a case where the light source is arranged immediately below a transmission portion in a case where the transmission portion is a figure indicating a switch, an illuminated photograph in a case where the light source is arranged at an upper left end of the transmission portion in a case where the transmission portion is a horizontal line, an illuminated photograph in a case where the light source is arranged immediately below the transmission portion, and partially enlarged views illustrating states of air bubbles in the display devices according to the fifth to eighth experimental examples and a second comparative example.

Hereinafter, the display devices according to the fifth to eighth experimental examples and the second comparative example will be described.

### Fifth Experimental Example

As illustrated in FIG. 4, a display device 30b according to the fifth experimental example includes a display sheet 10b including a skin sheet 12 formed with an elastomer material, a light shielding/smoke printing 14, a urethane foam (cushioning member) 16, and a transparent PC sheet (transparent member) 18, and a light source 20 including an LED lighting. The skin sheet had transparent material color and had processed leather embossment, and for printing, the light-shielding region was made black, and the transmission region was made smoke (transmittance: 12.5%). The skin sheet has a thickness of 0.3 mm.

The urethane foam (cushioning member) had a foaming ratio of 65, the number of air bubbles of 18 (/25 mm), an average air bubble diameter of 1.4 mm, and resin color of white. A thickness of the urethane foam was 3.5 mm. The transparent PC sheet (transparent member) had transparent resin color and a thickness of 0.25 mm.

### Sixth Experimental Example

The display sheet was formed in a similar manner to the fifth experimental example except that the urethane foam (cushioning member) had a foaming ratio of 64, the number of air bubbles of 20 (/25 mm), an average air bubble diameter of 1.2 mm, and a thickness of 3 mm.

### Seventh Experimental Example

The display sheet was formed in a similar manner to the fifth experimental example except that the urethane foam (cushioning member) had a foaming ratio of 57, the number of air bubbles of 30 (/25 mm), an average air bubble diameter of 0.8 mm, and a thickness of 3 mm.

### Eighth Experimental Example

The display sheet was formed in a similar manner to the fifth experimental example except that the urethane foam (cushioning member) had a foaming ratio of 50, the number of air bubbles of 40 (/25 mm), an average air bubble diameter of 0.6 mm, and a thickness of 3 mm.

### Second Comparative Example

The display sheet was formed in a similar manner to the fifth experimental example except that the urethane foam was not used.

### <Evaluation>

As illustrated in FIG. 5, if there is no urethane foam (second comparative example: no diffusion), the shape of the embossment on the surface of the skin member is visually recognized at the time of light emission display. In addition, in a case where the urethane foam has a low air bubble density (fifth experimental example), it can be seen that the shadow of the air bubbles is visually recognized at the time of light emission display. On the other hand, in a case where the air bubble density of the urethane foam is high (seventh and eighth experimental examples), it can be seen that it is difficult to visually recognize the shadow of the air bubbles and the shape of the embossment at the time of light emission display. In the shapes of the designs in both the seventh experimental example (average air bubble diameter: 0.8 mm) and the eighth experimental example (average air bubble diameter: 0.6 mm), the influence of the shadow of the air bubbles is small to the same extent. Thus, in consideration of the result of the fourth experimental example and the design shape, the average air bubble diameter is desirably 0.7 mm or less.

Note that if the air bubble density (the number of air bubbles) increases from 18 air bubbles/25 mm (fifth experimental example) to 40 air bubbles/25 mm (eighth experimental example), the illumination intensity decreases by about 20%.

According to the display device of the present disclosure, even in a case where a design portion is displayed with high luminance, shadow of air bubbles in a foam material constituting a cushioning member is hardly displayed as lighting unevenness on the design portion, and a display device with improved visibility of the design can be provided.

### REFERENCE SIGNS LIST

2 AIR BUBBLES IN FOAM MATERIAL
4 FOAM MATERIAL
10 DISPLAY SHEET
12 SKIN MEMBER
14 LIGHT SHIELDING/SMOKE LAYER
14a SMOKE LAYER
14b FIRST LIGHT SHIELDING LAYER
14c SECOND LIGHT SHIELDING LAYER
16 CUSHIONING MEMBER
18 TRANSPARENT MEMBER
20 LIGHT SOURCE
30 DISPLAY DEVICE

What is claimed is:

1. A display device comprising:
a display sheet having a front surface and a back surface, wherein the display sheet has a cushioning property and displays a design including a character/symbol on the front surface when light is emitted from the back surface; and
a light source that emits light from the back surface of the display sheet,
wherein the display sheet includes:
a skin member;
a light shielding/smoke layer disposed on the front side of the skin member or the back side of the skin member, and the light shielding/smoke layer constituting the design including the character/symbol;
a cushioning member disposed on the back side of the skin member, the cushioning member being formed with a foam material, and having a plurality of air bubbles, and having optical transparency for diffusing and transmitting irradiated light; and
a transparent member disposed on the back side of the cushioning member, and the transparent member being able to transmit irradiated light; and
wherein the cushioning member has an average diameter of the air bubbles in the foam material of 0.7 mm or less.

2. The display device according to claim 1, wherein the cushioning member has a foaming ratio of the foam material of 50 times or more and 100 times or less.

3. The display device according to claim 1, wherein the cushioning member has a total light transmittance of 40% or more.

4. The display device according to claim 1, wherein the skin member has a total light transmittance of 5% or more and 25% or less.
